(19) United States
(12) Patent Application Publication
(10) Pub. No.: US 2008/0049675 A1
(43) Pub. Date: Feb. 28, 2008

(54) METHOD AND SYSTEM FOR HAND-OFF BASED ON NETWORK LOAD

(75) Inventors: John M. Burgan, North Palm Beach, FL (US); Daniel A. Baudino, Lake Worth, FL (US); Jorge L. Perdomo, Boca Raton, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/466,606

(22) Filed: Aug. 23, 2006

(51) Int. Cl. H04Q 7/20

(52) U.S. Cl. 370/331; 455/436; 455/453

(57) ABSTRACT

A system (100), mobile device (102), and method (300) for network handoff of a mobile device in a multi-mode system is provided. The mobile device can include a first transceiver (210) and a second transceiver (220) for providing multi-mode communication. The method can include identifying (310) a first network load on a first network, identifying (320) a second network load on a second network, and switching (330) over from the first network to the second network if the first network load is greater than the second network load to balance a network load. The first network and the second network do not operate using the same modulation protocol.

### FIELD OF THE INVENTION

This invention relates generally to communications, and more particularly to communication networks.

### BACKGROUND OF THE INVENTION

The mobile device industry is constantly challenged in the market place for high quality, low-cost products which allow users to stay continually connected. Moreover, service providers and manufacturers are offering more services over more networks for keeping users connected. For example, streaming videos, blogs, or podcasts allow users to stay continually connected and informed. As users of mobile devices become more mobile, moving from one region to another, changes in coverage can affect signal quality reception and connectivity. For example, when the mobile device is in a vehicle that travels through different coverage regions, maintaining connectivity is a key concern. Users do not generally want a service disrupted during transitions from one cell site to another.

In general, a mobile device can connect only with cell sites that are owned or operated by a service provider of the mobile device. This is generally because the service provider uses a communication protocol that is particular to the mobile device and the infrastructure equipment. A service provider distributes a number of cell sites to provide coverage to mobile devices in high use areas. However, there may not be enough cell sites to adequately cover a geographic region to provide continuous connectivity. Consequently, there are regions where a cell site may not be able to transmit or receive communication from the mobile device. A user of the mobile device operated by the service provider will not be able to receive coverage in these areas. However, other service providers or networks may have cell sites in the area that are capable of providing coverage. These other cell sites operate on a different network and on different communication protocols. As a result, the different networks are not capable of communicating with the mobile device. Accordingly, a need exits for operating a mobile device over multiple communication networks.

### SUMMARY OF THE INVENTION

Embodiments of the invention are directed to a method and system for network handoff of a mobile device in a multi-mode system. A multi-mode system is a communication system which supports multiple communication protocols. The method can include identifying a first network load on a first network, identifying a second network load on a second network, and switching over from the first network to the second network if the first network load is greater than the second network load. In one arrangement, the first network and the second network do not operate using the same modulation protocol. For example, a base station of the first network operates using a modulation protocol with the mobile device that is not the same modulation protocol as a base station of the second network. The mobile device can include at least two transceivers for communicating simultaneously with both the first network and the second network. The mobile device can switch to a base station of a network provider based on a network loading.

In one aspect, a network load can identify a number of active users on a network. A first number of active users on the first network and a second network can be compared for determining whether to switch to the second network. If the network load is higher on the first network, the mobile device can switch over to the second network. In one aspect, the mobile device can also switch back to the first network if loading conditions change. The method can distribute a network loading of multiple mobile devices across multiple networks.

Furthermore, the method can include evaluating a first quality of a first communication for assessing the first network load, and evaluating a second quality of the second communication for assessing the second network load. The mobile device can switch over from the first network to the second network if the network quality is greater on the second network. The method can include identifying a first signal strength to the first network, and performing the switching over if the first signal strength to the first network is less than a second signal strength to the second network. A signal strength indicator and a quality signal indicator can be evaluated together to determine when to switch between the first network and second network.

In one arrangement, a network loading can be evaluated for routing calls based on the active number of users. Calls can be routed to a mobile device based on a network loading. As an example, a mobile device capable of receiving multiple communications can receive a call on a communication that has less active users. A central office can direct a call to a mobile device on a network that has less network loading. Moreover, a location of the mobile device can be predicted, and a communication mode can be selected prior to routing the call based on the location.

### BRIEF DESCRIPTION OF THE DRAWINGS

FIG. 1 is a diagram of a multi-mode communication system within a mobile communication environment;

FIG. 2 is a schematic of a mobile device in accordance with the embodiments of the invention;

FIG. 3 is a method for network hand-off in a multi-mode communication system in accordance with the embodiments of the invention;

FIG. 4 is an illustration of the method of FIG. 3 in accordance with the embodiments of the invention;

FIG. 5 is a more detailed method of FIG. 3 for network hand-off in a multi-mode communication system in accordance with the embodiments of the invention;

FIG. 6 is a first illustration of the method of FIG. 5 in accordance with the embodiments of the invention; and

FIG. 7 is a second illustration of the method of FIG. 5 in accordance with the embodiments of the invention.

### DETAILED DESCRIPTION OF THE DRAWINGS

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processor” can be defined as any number of suitable processors, controllers, units, or the like that carry out a pre-programmed or programmed set of instructions. The term “transceiver” can be defined as a software or hardware component capable of providing both transmit and receive communications for at least one network. A transceiver may provide multiple transmit and receive communications to more than one network simultaneously. The term “hand-off” can be defined as negotiating a change of communication between a first communication system and a second communication system. The term “signal strength” can be defined as a measure of voltage or current or other suitable parameter of a communication signal. The term “signal quality” can be defined as an objective or subjective measure of a reception quality of a communication signal. The term “switching over” can be defined as directing a communication hand-off between two communication systems. The term “active user” can be defined as a user that is in an established communication session. The term “network load” can be defined as a number of active users in a communication session. The term “modulation protocol” can be defined as a mathematical operation to modulate a communication signal. The term “communication protocol” can be defined as a manner to control communication processes.

Embodiments of the invention are directed to a mobile device having multi-transceiver capabilities that can hand-over to different networks, some of which operate under a different communication protocol. Briefly described, the mobile device can change to a cell site based on a signal strength and a network loading. The network loading identifies the number of active users on one or more networks. The mobile device can hand-off to cell sites on different networks having a lower network loading. Moreover, calls can be distributed to mobile devices over different networks in accordance with the network load. Furthermore, the mobile devices can hand-off to cell sites which are owned or operated by other service providers based on a network loading if a coverage to those cell sites is preferable. For example, a mobile device may receive a high signal strength to a cell site that does not operate using the same communication protocol by a service provider of the mobile device. The mobile device can hand over to the higher signal strength network, and switch to a communication protocol of the higher signal strength network.

In particular, mobile devices, such as a radio or cell phone, can include multiple transceivers for providing multiple communication operations. The mobile devices can support multiple processing cores and multiple simultaneous communication protocols. The mobile device can employ multiple transceivers that operate over different modulation protocols on different networks to achieve “seamless mobility”, thereby allowing users to stay continually connected. The mobile device can connect to different networks that may each operate in an asynchronous manner. That is, each transceiver may operate independently of the other transceivers on the mobile device. The mobile device can hand-off between different networks by switching communication protocols wherein the hand-off is determined based on a network loading and a signal strength. The hand-off to different networks distributes the network load and can decrease a number of dropped calls; that is, the hand-off controls network loading and a premature termination of active calls. The hand-off also allows users to roam through areas operated by multiple networks having varying capacities.

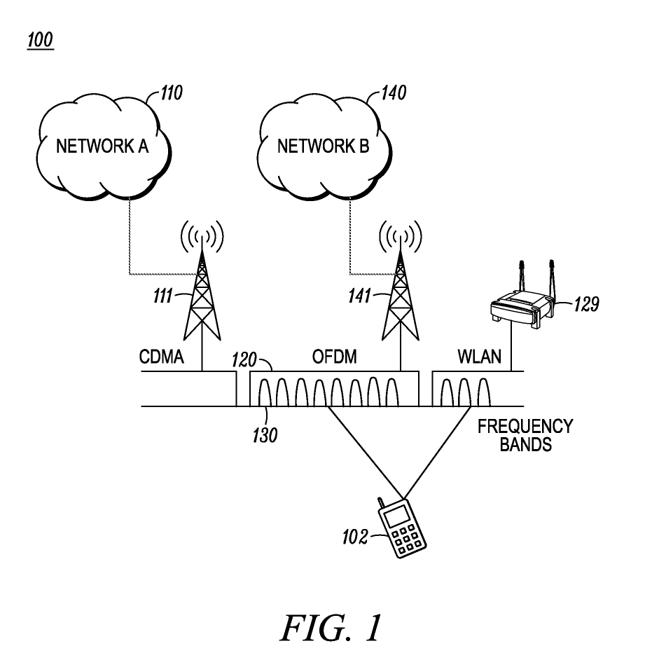

Referring to FIG. 1, a multi-mode communication system 100 for providing mobile communication is shown. The multi-mode communication system 100 can include one or more subscribers, such as mobile device 102, communicatively coupled to one or more networks. The mobile device 102 can connect to a first network 110 through base station 111, and a second network 140 through base station 141. The mobile device 102 can be a radio, a cell phone, a personal digital assistant, a mobile communication device, a public safety radio, a portable media player, or any other suitable communication device. In one aspect, a plurality of mobile devices 102 can operate within the multi-mode communication environment 100 for providing group call or dispatch communication in addition to cellular or ad-hoc communication. Briefly, the mobile device 102 can connect to multiple networks over various communication protocols (e.g. modulation protocols). The mobile device 102 can switch coverage between networks operated by various service providers having different modulation protocols based on a network loading. In one aspect, the mobile device can switch to another network to reduce load on one network irrespective of signal quality. In another aspect, the mobile device can switch to improve signal quality irrespective of load. That is, the mobile device can switch to a network for reducing a loading and/or improving a quality of a communication.

The mobile communication system 100 can provide wireless connectivity over a radio frequency (RF) communication network such as a base station 111, also known as a tower. Notably, base station 141 can operate similarly to base station 111, though over a different communication protocol. The base station 111 may be a base receiver, a central office, a network server, or any other suitable communication device or system for communicating with the one or more mobile devices. The mobile device 102 can communicate with one or more cellular towers 111 and 141 using a standard communication protocol such as Time Division Multiple Access (TDMA), Global Systems Mobile (GSM), Orthogonal Frequency Division Multiplexing (OFDM), Code Division Multiple Access (CDMA), or integrated Dispatch Enhanced Network (iDEN), or any other suitable multiple access modulation protocol. The base stations 111 and 141 can be part of a cellular infrastructure or a radio infrastructure containing standard telecommunication equipment as is known in the art.

In another arrangement, the mobile device 102 may also communicate over a wireless local area network (WLAN). For example the mobile device 102 may communicate with a router 129, or an access point (not shown) for providing packet data communication. In a typical WLAN implementation, the physical layer can use a variety of technologies such as 802.11b or 802.11g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology. The mobile device can also switch over from a cellular network (110 or 140) to a WLAN network for handling a call or for other media activities, such as messaging. For example, the mobile device 102 may temporarily hand-off to the router 129 on the WLAN to balance a network loading on 110 or 140.

In particular, the base station 111, base station 141, or the router 129, can support one or more frequency bands 120. In general, the base station 111, base station 141, or the router 129 may be responsible for allocating frequency channels to the mobile device 102. Once assigned a frequency channel 130, the mobile device 102 can communicate over a network using the assigned frequency. Notably, depending on the form of communication, various frequency channels may be available. That is, the mobile device 102 may be capable of operating over multiple frequency channels using multiple access communications. The mobile device 102 can also receive communication over the assigned frequency channel.

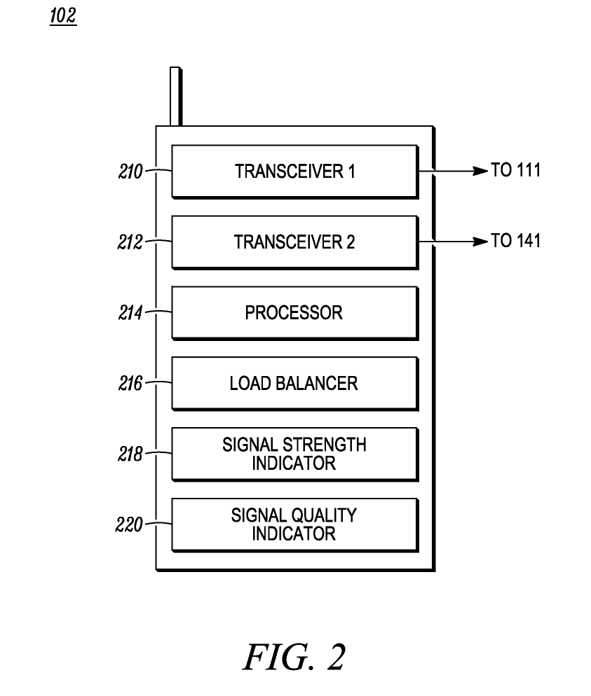

Referring to FIG. 2, a block diagram of the mobile device 102 is shown. The mobile device 102 can include a first transceiver 210 for providing a first communication to a first network, a second transceiver 212 for providing a second communication to a second network, and a processor 214 for switching over from the first network to the second network if a first network load is greater than a second network load. A network loading can be a number of users. Accordingly, a first network having a greater load than a second network has more active users. The loading can also include the level of resources used by the users. For example, a user downloading video data may require more network resources such as bandwidth to download data versus a user performing text messaging. Accordingly, network loading also refers to the level of resources utilized for supporting one or more users. The mobile device 102 can receive communication signals from either the base station 111, base station 141, or the router 129 (See FIG. 1). Other telecommunication equipment can be used for supporting communication and embodiments of the invention are not limited to only those components shown.

As one example, the mobile device 102 may receive a UHF radio signal having a carrier frequency of 600 MHz for communicating with Network A 110 through base station 111, a CDMA communication signal having a carrier frequency of 900 MHz for communicating with Network B 140 through base station 141, or a IEEE-802.11x WLAN signal having a carrier frequency of 2.4 GHz for communicating with an access point through router 129. Notably, the first transceiver 210 and the second transceiver 212 may not operate using the same modulation protocol. In one arrangement, the mobile device 102 can simultaneously receive the communication signals across the frequency spectrum 50 MHz to 7 GHz. In one arrangement, a transceiver may include a wideband linear amplifier?? to linearly amplify communication signals across multiple bands that span multiple communication systems operating across various frequencies. In this manner, a single transceiver may support multiple modulation protocols in a single chip design.

The mobile device can include a load balancer 216 for assessing a first load on the first network and a second load on the second network and balancing the first load and the second load between the first network and the second network. A network load may be a number of active users on a network. The load balancer 216 can determine a number of users on one or more networks, and route communications to the mobile device based on the network load. The mobile device can also include a signal strength indicator 218 for monitoring a first signal strength to the first network and a second signal strength to the second network. The mobile device 102 can also include a signal quality indicator 220 for evaluating a first quality of the first communication and a second quality of the second communication. In practice, the processor 214 can switch over from the first network to the second network if the second signal strength is greater than the first signal strength and the second quality is greater than the first quality.

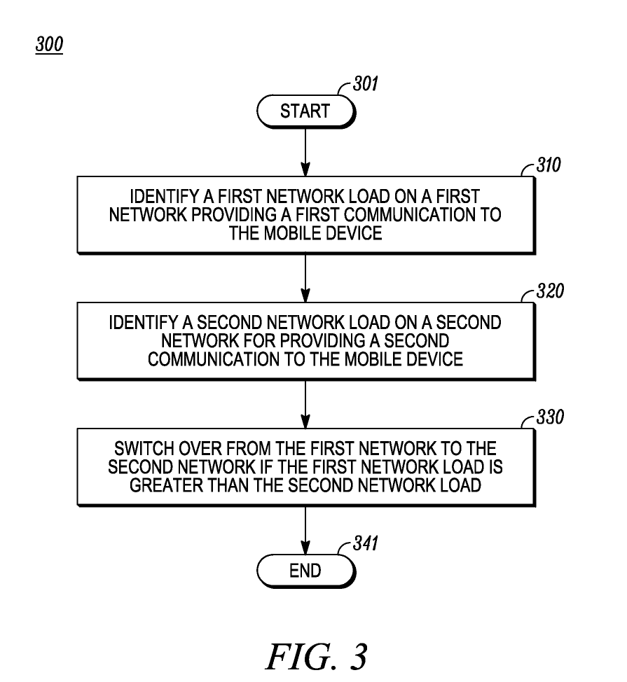

Referring to FIG. 3, a method 300 for network handoff of a mobile device in a multi-mode system is shown. The method 300 can be practiced with more or less than the number of steps shown. To describe the method 300, reference will be made to FIGS. 1, 2, and 4 although it is understood that the method 300 can be implemented in any other suitable device or system using other suitable components. Moreover, the method 300 is not limited to the order in which the steps are listed in the method 300. In addition, the method 300 can contain a greater or a fewer number of steps than those shown in FIG. 3.

At step 301, the method 300 can start. The method 300 can start in a state wherein the mobile device 102 is in a coverage area of a first network and transitioning to a coverage area of a second network. The first network 110 may be operated by a first service provider, and the second network 140 may be operated by a second service provider. However, the first network and second network are not limited to being operated by different service provider. A single service provider can operate multiple networks having different communication protocols. The first network and the second network may operate over different communication protocols as discussed in FIG. 1.

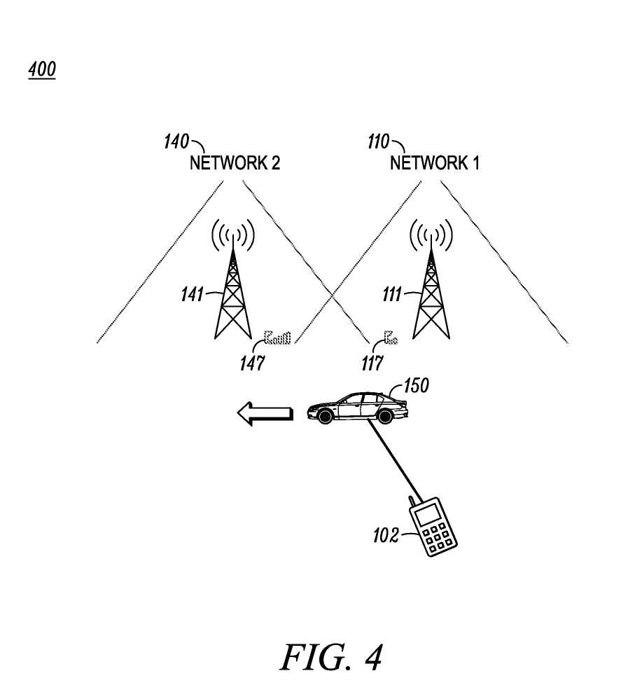

Briefly referring to FIG. 4, an illustration 400 of handing over from a first network to a second network is shown. Handing over can be defined as relinquishing communication capabilities on a first communication system and passing over the responsibilities to another multi-mode communication system. The mobile device 102 can be in a coverage area of the first network 110 and receiving a first communication from base station 111. The mobile device 102 can have a strong signal strength 117 when it is in close proximity to the base station 111. The signal strength indicator 218 (See FIG. 2) can identify strong signal strength 117 reception which indicates good coverage. The mobile device 102 may be in a vehicle 150 that is moving from a cell site operated by a first network 110 to a cell site operated by a second network 140. The signal strength 117 can lower as the device moves away from the base station 111.

Referring back to FIG. 3, at step 310, a first network load on a first network providing a first communication to the mobile device can be determined. A network load can be a number of active users on a network. As an example, the mobile device 102 may communicate with the first network over an iDEN communication protocol using transceiver 210 (See FIG. 2). Understandably, the first network may communicate with the mobile device 102 using various other modulation protocols. The load balancer 216 (see FIG. 2) can determine a number of active users on the first network 110. For example, the load balancer 216 can query the base station 111 for user information, such as the number of active subscribers. Alternatively, the base station 111 can report the number of active users to the mobile device 102. The mobile device 102 may determine the number of active users when the signal strength indicator 218 determines that a hand-off is necessary to maintain a reception coverage. Referring back to FIG. 4, as the vehicle 150 moves away from the base station, the signal strength indicator 218 (see FIG. 2) may detect a decrease in signal strength 117 which triggers the load balancer 216 to inquire network loading conditions on neighbor networks. The signal strength 117 may be a power level of a received communication signal expressed in decibels.

At step 320, a second network load on a second network for providing a second communication to the mobile device can be determined. As an example, the mobile device 102 may communicate with the second network over a CDMA communication protocol using transceiver 212 (See FIG. 2). Understandably, the second network may communicate with the mobile device 102 using various other modulation protocols. Referring to FIG. 4, upon detecting a decrease in signal strength 117, the mobile device 102 can determine the number of active users on the second network 140. For example, the mobile device 102 can query the base station 141 for the active number of users, or the base station 141 can report the active number of users. As the signal strength 117 from the first network 110 decreases to the mobile device 102, the signal strength indicator 218 (See FIG. 2) can also identify a signal strength 147 to the second network 140.

At step 330, the mobile device can switch over from the first network to the second network if the first network load is greater than the second network load. That is, the mobile device may switch networks if a loading on the networks is unbalanced; that is, there are more users on one network than another network. It should also be noted that the mobile device 102 may switch to the second network even if the signal strength 147 to the second network is less than the signal strength 117 to the first network.

Referring again to FIG. 4, the mobile device 102 can determine a number of active users on the first network, and compare the number of active users on the first network 110 to a number of active users on the second network 140. The mobile device 102 can switch over to the second network if the number of active users on the second network is less than the number of active users on the first network. The first network 110 can send a signal to a central office to generate a hand-off to the second network 140. Notably, the first network 110 and the second network 140 operate over a different communication protocol. In this case, the mobile device 102 switches over when a network loading and a signal strength to one network is preferable to another network.

In particular, the mobile device 102 can switch over to the second network 140 if the load balancer 218 (See FIG. 2) determines that there are fewer active users on the second network. In practice, the mobile device 102 switches over as a function of the signal strength and the network load. For example, the mobile device assesses network loading conditions only when the signal strength indicator 218 (see FIG. 2) determines that a network switch is necessary. The mobile device 102 switches over to the second network 140 if the second signal strength 147 to the second network 140 is greater than the first signal strength 117 to the first network 140. Moreover, the mobile device 102 generally attempts to first switch over to base stations owned or operated by the same service provider operating under the same communication protocol before attempting to switch over to a non-network service provider. At step 341, the method 300 can end.

In another arrangement, the mobile device can switch over from the first network 110 to the second network 140 if a quality of a network loading is greater than the second network load. For example, referring back to FIG. 2, the signal quality indicator 220 can measure a quality of a communication to the first network 110 and the quality of a communication to the second network 140. The quality may be a subjective quality such as a perceptual quality of voice, or an objective quality such as a bit error rate. In particular, the signal quality indicator 220 can rate the quality of a communication based on a network loading. It should be noted that the quality of a CDMA communication decreases as the number of active users increase. This is a result of sharing bandwidth between multiple users. In contrast, a TDMA system has assigned time slots wherein the quality of the communication is a function of a communication channel. For example, a quality of a TDMA communication deteriorates due to fading or noise. However, the quality on a TDMA system does not decrease as the number of users increase since each user is assigned an individual time slot. Notably, the signal quality indicator 220 can measure a quality due to network loading as a result of sharing bandwidth on multiple access systems.

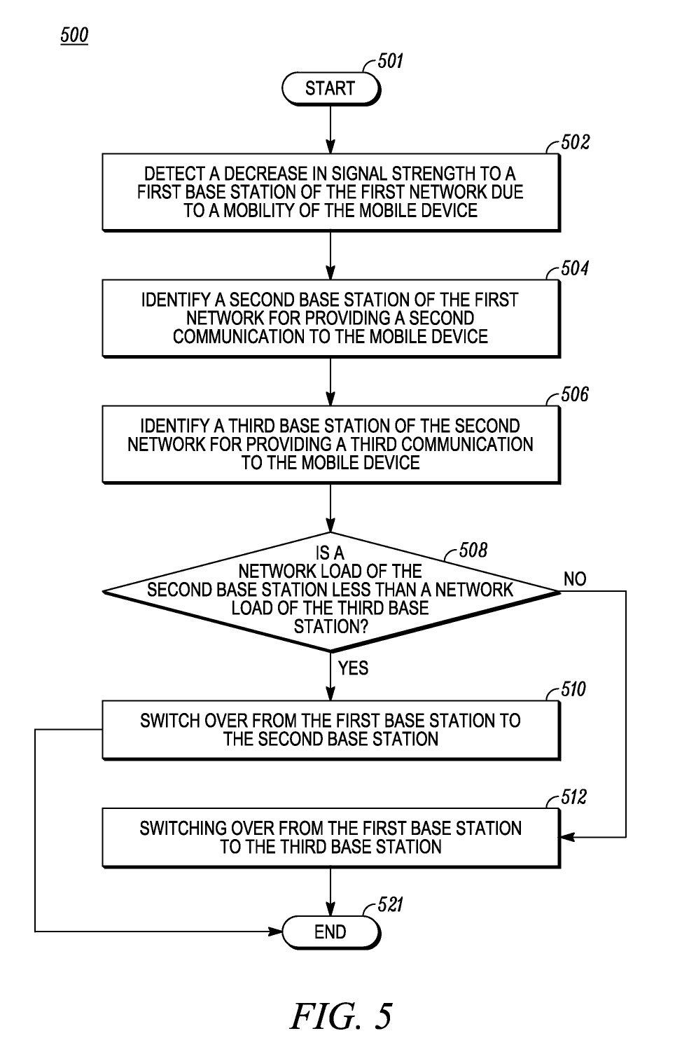

Referring to FIG. 5, a more detailed description of the method 300 is shown. The method 500 can be practiced with more or less than the number of steps shown. To describe the method 500, reference will be made to FIGS. 1, 2, 6, and 7 although it is understood that the method 500 can be implemented in any other suitable device or system using other suitable components. Moreover, the method 500 is not limited to the order in which the steps are listed in the method 500. In addition, the method 500 can contain a greater or a fewer number of steps than those shown in FIG. 5.

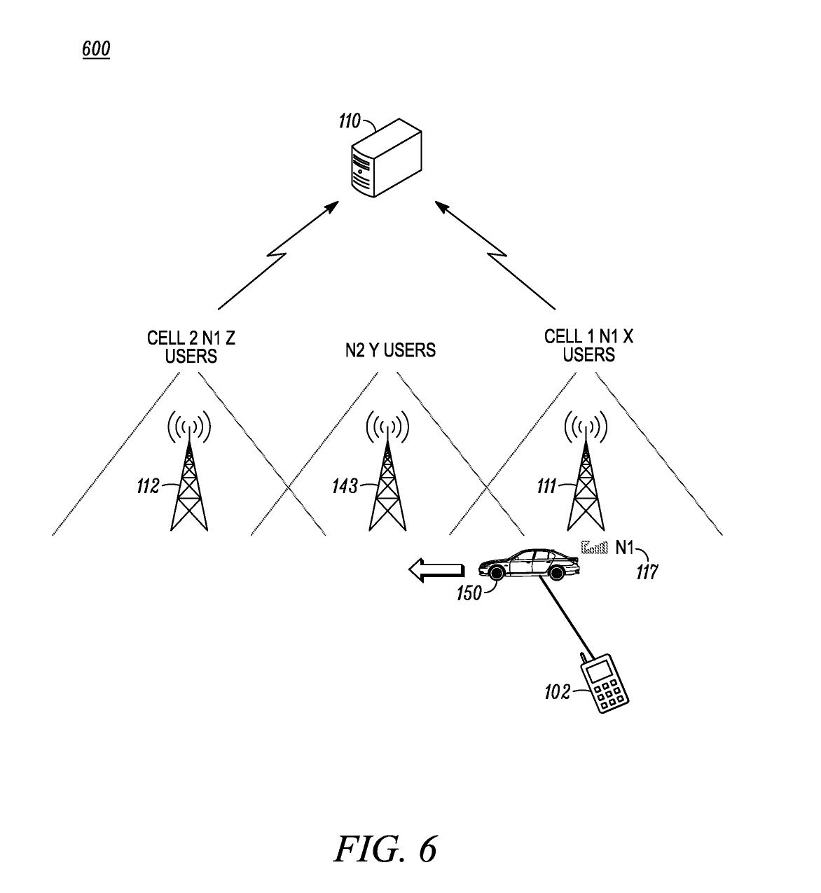

At step 501, the method can start. The method 500 can start in a state wherein the mobile device 102 is in a coverage area of a first base station and transitioning to a coverage area of a second base station. The first base station and the second station can be operated by a first network. A third base station operated by a second network can also provide coverage between the first base station and the second base station. Briefly referring to FIG. 6 an illustration 600 of handing over from a first network to a second network is shown as described in the context of multiple base stations operated by multiple service providers. For example, the mobile device 102 may be in a vehicle 150 that is moving in a direction from base station 111 operated by Network A 110 to base station 112 also operated by Network A 110. The mobile device 102 can be in a coverage area of the first network 110 and receiving a first communication from base station 111. The mobile device 102 can have a strong signal strength 117 to Network A 110 when it is in close proximity to the base station 111. Network A 110 may also be a server which can select at least one communication mode of the mobile device based on a network loading. The server 110 can identify a network loading and perform a switch from a first network to a second network to balance the network loading on the first network and the second network.

At step 502, the mobile device can detect a decrease in signal strength to a first base station of the first network due to a mobility of the mobile device. Recall, the signal strength indicator 218 (See FIG. 2) of the mobile device 102 can identify strong signal strength 117 reception to base station 111 which indicates good coverage. As the vehicle 150 and the mobile device 102 within the vehicle move in a direction from base station 111 to base station 112, the signal strength indicator 218 can identify a decrease in signal strength 117 to base station 111.

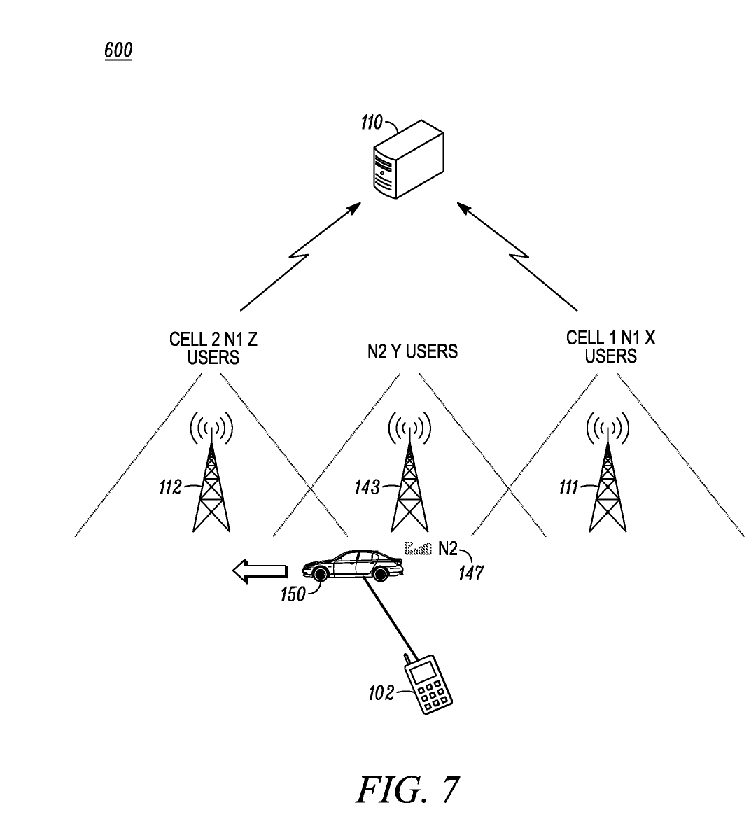

At step 504, the mobile device can identify a second base station of the first network for providing a second communication to the mobile device. For example, referring to FIG. 7, the mobile device 102 can determine that base station 112 operated by network A 110 is the next closest cell site using the same communication protocol to receive coverage. Moreover, base station 112 may also be operated by a same service provider of base station 111. However, base station 112 may not provide sufficient coverage when the vehicle is directly between base station 111 and base station 112.

At step 506, the mobile device can identify a third base station of the second network for providing a third communication to the mobile device. Referring to FIG. 7, base station 143, which is operated by Network B 140, is capable of providing coverage. Notably, the signal strength 147 to network B 140 can increase as the device enters the proximity of base station 143. Understandably, in the illustration shown, the mobile device 102 is closer to base station 143 than base station 112 which results in a higher signal strength. When the vehicle 150 is in proximity of base station 143, the coverage to Network B is of a higher reception that to Network A through either base station 111 or base station 112.

Notably, Network A 110 and Network B 140 operate using different communication protocols. For example, Network A 110 may communicate with mobile device 102 using an iDEN communication protocol, and Network B 140 may communicate with mobile device 102 using a CDMA communication protocol. Understandably, the first network and the second network may communicate with the mobile device 102 using various other modulation protocols, as they are not limited to these particular examples.

At step 508, a determination can be made as to whether the network load of the second base station is less than a network load of the third base station. A network load can be the number of active users on the network. If the network load of the second base station 112 is less than a network load of the third base station 143, at step 510, the mobile device 102 can switch over from the first base station 111 to the second base station 112. Else, at step 512, the mobile device 102 can switch over from the first base station 111 to the third base station 143 if the network load of the second base station 112 is greater than the network load of the third base station 143. Notably, the first base station 111 and the second base station 112 are both of the first network 110 and operate using a same modulation protocol. The third base station 143 of the second network 140 operates using a modulation protocol that is not the same modulation protocol as the first network 110. The mobile device 102 can also switch back to Network A 110 if signal strength conditions increase or a network loading makes base stations 111 and 112 preferable over base station 143. Switching over from the first network 110 to the second network 140 can include requesting a handover to the second network, establishing a second connection to the second network, confirming the handover to the second network, and releasing a first connection to the first network.

Briefly, referring back to FIG. 7, if the vehicle 150 moves to a location where a communication signal is weak (e.g. low signal strength) then the mobile device can request a hand-off. As an example, the mobile device 102 can request a hand-off to base station 143 or base station 112. Referring to FIG. 2, the signal strength indicator 218 can determine the signal strength of the communication to the first network A 110 and the second network B 140. The load balancer 216 can determine the active number of users on Network A 110 and Network B 140, and the signal quality indicator 220 (See FIG. 2) can assess a quality of the communication to Network A 110 and Network B 140. The mobile device 102 can also determine if the base stations 112 and 147 have reached their maximum number of users in view of the determined number of active users.

The mobile device 102 can hand-off to either base station 110 or base station 147 based on the number of users and/or the measured quality. As previously noted, a multiple access communication may allow for a greater number of users wherein the quality of communication is a function of the number of users. For example, if the signal strength to base station 112 is higher than that of base station 143, and the active number of users on base station 143 is lower than on base station 112, the mobile device can switch to Network B 140 through base station 143. The quality and signal strength to base station 143 may be preferable to base station 112.

If the base station 143 is close to, or has reached a capacity of users, the quality of the communication to base station 143 may be low. In this case, the mobile device may elect to stay in network A 110 and use base station 112 for communication purposes. However, the mobile device 102 may decide to switch to Network B 140, even though Network B is at full capacity if base station 143 has stronger signal strength than base station 112. That is, the mobile device 102 may intentionally switch over to base station 143, which is at full capacity, to ensure continued connectivity. At full capacity, base station 143 can provide continuous coverage, though, with low communication quality.

Alternatively, the user may be willing to sacrifice connectivity for occasional quality. Accordingly, the mobile device 102 may select base station 110 even if the signal strength is lower at times to avoid the continuous low quality communication to base station 143. That is, the quality to base station 112 may be sporadic, though of high quality, in contrast to base station 143 which may be continuous and of poorer quality. The mobile device 102 can include a user setting that allows the user to determine preferred communication mode settings and automatically configure hand-off preferences.

In one arrangement, the mobile device 102 can assess network loading conditions for routing a call based on the network loading. For example, the mobile device can evaluate a quality of a communications to one or more networks, and a number of users to the one or more networks. Calls can be routed for distributing a loading across multiple networks. When network conditions change, calls can be routed back to their original networks. Briefly, referring back to FIG. 2, the first transceiver 210 may handle a first call to the first network A 110, and the second transceiver 212 may handle a second call to the second network B. The mobile device 102 can predict a location of the mobile device based on a movement of the mobile device. For example, referring back to FIG. 4, the mobile device 102 can predict a direction of the vehicle 150 based on previous measurements. The mobile device 102 can then convey the location information to a central office, which can then assess neighbor cells in the area. A communication mode can be selected prior to routing a call based on the location. For example, a network can identify a location based on predicting a direction of the vehicle 150. The mobile device or the network can select a communication mode, such as a CDMA mode, an iDEN mode, or any other suitable communication protocol. The mobile device 102 or the base stations may report a network loading, such as the number of users to the central office. Based on the location information and the network loading, the central office can direct, or route, calls to the mobile device. For example, the central office can determine Network A 110 has lower network loading than Network B. Accordingly, calls can be routed to the mobile device 102 over network B 140 through base station 143. Moreover, the central office can determine a communication mode associated with lower loading.

In practice, a call can be set-up based on current network usage and a signal strength. Moreover, after the call is set-up, the different networks can determine when to hand-off the call based on varying network load conditions and signal strengths.

For example, a user registered may be registered on both network A 110 and network N 140; this is characteristic of a dual camp system. A dual mode server on the central office can maintain the dual mode connectivity to the mobile device 102 and track the user on Network A 110 and Network B 140. The dual mode server can assign calls initiated by the mobile device and distribute the load across the two networks (110 and 140).

In yet another embodiment, incoming calls can also be routed to one or the other network based on the load and location of the mobile device. For example, a Mobile Terminal Service Office (MTSO) can query the dual mode server system to identify where the call should be routed. The routing can be based on the network load, signal strength, and location of the mobile device. The ability to select a preferred mode of operation before a call is received by a mobile device can enhance a user's perception of quality. For instance, if the mobile device is operating in dual mode iDEN and CDMA, the MTSO can determine which network to route the call based on a network load, signal strength, and location of the mobile device. The mobile device 102 or the MTSO can determine when the user is traveling through a region supporting both iDEN and CDMA because the network has knowledge based on a network layout that identifies a location of the mobile device. The network layout can determine where the mobile device will lose coverage. The MTSO can route the call to the proper network and reduce the number of hand-offs based on the network layout. Accordingly, fewer hand-offs will be performed thereby providing a seamless connectivity across disparate networks and providing robustness to dropped calls. This will allow the network to establish and maintain smart connections and manage future handoffs efficiently in the network.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not limited. Numerous modifications, changes, variations, substitutions and equivalents will occur to those skilled in the art without departing from the spirit and scope of the present embodiments of the invention as defined by the appended claims.

What is claimed is:

1. A method for network handoff of a mobile device in a multi-mode system, comprising:
identifying a first network load on a first network providing a first communication to the mobile device;
identifying a second network load on a second network for providing a second communication to the mobile device; and
switching over from the first network to the second network if the first network load is greater than the second network load,
wherein the first network and the second network do not operate using the same modulation protocol.

2. The method of claim 1, wherein identifying a network load further comprises:
determining a number of active users on the first network; and
comparing the number of active users on the first network and a number of active users on the second network.

3. The method of claim 2, wherein the switching over further comprises:
identifying a first signal strength to the first network; and
performing the switching over if the first signal strength to the first network is less than a second signal strength to the second network.

4. The method of claim 1, wherein identifying a network load further comprises:
evaluating a first quality of the first communication for assessing the first network load; and
evaluating a second quality of the second communication for assessing the second network load.

5. The method of claim 1, further comprising:
detecting a decrease in signal strength to a first base station of the first network due to a mobility of the mobile device;
identifying a second base station of the first network for providing a second communication to the mobile device;
identifying a third base station of the second network for providing a third communication to the mobile device; and
switching over from the first base station to the second base station if a network load of the second base station is less than a network load of the third base station, else, switching over from the first base station to the third base station if the network load of the second base station is greater than the network load of the third base station,
wherein the first base station and the second base station are both of the first network and operate using a same modulation protocol, and the third base station of the second network operates using a modulation protocol that is not the same modulation protocol.

6. The method of claim 5, further comprising:
switching back to the first network if the first network load decreases below the second network load.

7. The method of claim 5, further comprising:
distributing a network loading of a plurality of mobile devices across a plurality of networks.

8. The method of claim 1, wherein the switching over from the first network to the second network further comprises:
requesting a handover to the second network;
establishing a second connection to the second network;
confirming the handover to the second network; and
releasing a first connection to the first network.

9. The method of claim 1, further comprising:
routing calls to one or more networks based on a network load.

10. The method of claim 9, further comprising:
predicting a location of the mobile device; and
selecting a communication mode prior to routing a call based on the location.

11. A system for network handoff, comprising:
a server for selecting at least one communication mode of a mobile device based on a network loading;
a first network having a first loading associated with a first communication mode;
a second network having a second associated with a second communication mode,
wherein the server identifies the first or second network having a lower loading and performs a switch from the first network to the second network to balance the network loading on the first network and the second network.

12. The system of claim 11, wherein the first network and the second network do not operate using the same modulation protocol.

13. The system of claim 11, wherein the mobile device further comprises:
a first transceiver for providing the first communication;
a second transceiver for providing the second communication; and
a processor for monitoring the network handoff associated with the switching over,
wherein the first transceiver and the second transceiver do not operate using the same modulation protocol.

14. The system of claim 13, wherein the processor:
identifies a first network load on the first network;
identifies a second network load on the second network; and
switches over from the first network to the second network if the first network load is greater than the second network load.

15. The system of claim 14, wherein the first network reports a first number of active users on the first network to the mobile device, and the second network reports a second number of active users to the mobile device.

16. The system of claim 15, wherein the mobile device queries the first network and queries the second network to assess a network loading.

17. The system of claim 13, wherein the processor
evaluates a first quality of the first communication for assessing the first network load; and
evaluates a second quality of the second communication for assessing the second network load.

18. A mobile device for network handoff, comprising:
a first transceiver for providing a first communication to a first network;
a second transceiver for providing a second communication to a second network;
a processor for switching over from the first network to the second network if a first network load is greater than a second network load; and
a load balancer for assessing a first load on the first network and a second load on the second network and balancing the first load and the second load between the first network and the second network,
wherein the first transceiver and the second transceiver do not operate using the same modulation protocol.

19. The mobile device of claim 18, further comprising:
a signal strength indicator for monitoring a first signal strength to the first network and a second signal strength to the second network;
a signal quality indicator for evaluating a first quality of the first communication and a second quality of the second communication,
wherein the processor switches over from the first network to the second network if the second signal strength is greater than the first signal strength and the second quality is greater than the first quality.

20. The mobile device of claim 18, wherein the processor:
identifies a second base station of the first network for providing a second communication to the mobile device;
identifies a third base station of the second network for providing a third communication to the mobile device; and
switches over from the first base station to the second base station if a network load of the second base station is less than a network load of the third base station, else, switches over from the first base station to the third base station if the network load of the second base station is greater than the network load of the third base station,
wherein the first base station and the second base station are both of the first network and operate using a same modulation protocol, and the third base station of the second network operates using a modulation protocol that is not the same modulation protocol.
